(19) United States
(12) Patent Application Publication
(10) Pub. No.: US 2011/0003649 A1
(43) Pub. Date: Jan. 6, 2011

(54) Composite Golf Club Head and Fabrication Method Thereof

(75) Inventor: Cheng-Kung Liu, Kao-Hsiung Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: Jui-Kuen Kuo, Kao-Hsiung Hsien (TW)

(21) Appl. No.: 12/834,602

(22) Filed: Jul. 12, 2010

Related U.S. Application Data
(63) Continuation-in-part of application No. 12/017,238, filed on Jan. 21, 2008, now abandoned.

(30) Foreign Application Priority Data
Feb. 12, 2007 (TW) 096202613

(51) Int. Cl. A63B 53/04; B23P 11/00; B23P 17/00

(52) U.S. Cl. 473/342; 473/345; 473/349; 473/350; 29/525.14; 29/527.1

(57) ABSTRACT

The present invention provides a composite club head and a fabrication method thereof. The fabrication method for a composite golf club head includes steps of: preparing a head shell part having an opened front, a flange around the opened front, and a trench on the flange, and a front plate part made of a first material containing a metal and having a protrusion; connecting the head shell part with the front plate part by engaging the trench and the protrusion; drilling a hole passing through the flange and the front plate part; screwing the head shell part and the front plate part through the hole by a second material containing the metal; and welding the first and the second materials.

### CROSS-REFERENCE TO RELATED APPLICATIONS

This application is continuation-in-part application of U.S. patent application Ser. No. 12/017,238, field Jan. 21, 2008 and hereby incorporates the content of this application by reference.

### FIELD OF THE INVENTION

The present invention relates generally to an improved composite golf club head and a fabrication method thereof. More particularly, the present invention relates to a composite metal golf club head and a fabrication method thereof.

### BACKGROUND OF THE INVENTION

The complexities of golf club design are well known. The specifications for each component of the club (i.e., the club head, shaft, hosel, grip, and sub-components thereof) directly impact the performance of the club. Thus, by varying the design specifications, a golf club can be tailored to have specific performance characteristics.

The design of club heads has long been studied. Among the more prominent considerations in club head design are loft, lie, face angle, horizontal face bulge, vertical face roll, face progression, face size, sole curvature, center of gravity, material selection, and overall head weight. While this basic set of criteria is generally the focus of golf club engineering, several other design aspects must also be addressed. It is found that the club head are generally made of steel materials or ferrous materials for the fabrication conditions and the different purpose thereof. Hence, the overall head weight, the shock absorbance, or the coefficient of rebound of such club head are not ideal.

Along with the development of metallurgy, presently titanium and alloy thereof are provided for various fields. Products made of titanium or alloy thereof are famous for the corrosions resistance, the light weight and the highly rigidity thereof. Hence, some manufactories combine titanium-containing face with the head body to form a composite club head.

Presently, means for combining of the titanium containing face and the head body is welding technology. However, welding these two components (the titanium containing face and the head body being made of steel or ferrous materials) with their physical properties being quite different, such as the melting points thereof, the heat conductivities thereof, the thermal expansion coefficient thereof, and etc. needs more pretreatment processes, such as electroplating and chemical deposition, or it must be carried out by special welding technology, for example, the explosive welding. In addition, club heads fabricated by such methods are not only easily disengaging the face from the main body, but also the transmitting of the hitting force thereof is affected, which changes the inertia trajectory thereof and reduce the stability thereof. Hence, the presently used methods, as mentioned above, are either complicate or difficult, and the club head fabricated thereby are not ideal.

Thus, the club face and body should be designed to resist the repeated impacts that occur during collisions between the golf club and the golf ball Therefore, there is a need to develop a composite club head and a fabrication method thereof that can overcome the above drawbacks.

### SUMMARY OF THE INVENTION

According to the above drawbacks, an objective of the present invention is to provide a lighter, simpler, stronger and more stable composite club head and a fabrication method thereof.

Another objective of the present invention is to provide a composite club head and a fabrication method thereof, wherein the composite club head has a bigger sweet spot area, preferably, to an extent that equals to the hitting front.

Still another objective of the present invention is to provide a composite club head with better reliance, better buffering (impact absorption), and greater carry distance and a fabrication method thereof.

In order to attain the above and other objectives, the present invention discloses a composite golf club head, comprising: an open-front hollow main body part, a front plate part and a screw, wherein the open-front hollow main body part has a trench and a first hole passing through the trench, the front plate part is made of a first material containing a metal and has a protrusion and a second hole, which is disposed on the protrusion and passing through the front plate part; the second hole is corresponding to the first hole; the front plate part is attached to the front of the main body part by an engaging of the protrusion and the trench; and the screw is made of a second material containing the metal and secures the engaging by passing through the holes and welding with the front plate part.

Preferably, the trench is disposed at a periphery of the front.

Preferably, the front plate part is a cup-shaped plate.

Preferably, the protrusion is disposed at a periphery of the front plate part.

Preferably, the holes are through holes, and the front plate part and the main body part are screwed by the holes and the screw before the welding.

Preferably, the main body part is made of one of a steel material and a ferrous material.

Preferably, the main body is one of an iron club head, a wood club, and a putter head.

Preferably, the metal is one of titanium and a maraging steel.

In order to attain the above and other objectives, the present invention also discloses a fabrication method for a composite golf club head, comprising steps of: preparing a head shell part having an opened front, a flange around the opened front, and a trench on the flange, and a front plate part made of a first material containing a metal and having a protrusion; connecting the head shell part with the front plate part by engaging the trench and the protrusion; drilling a hole passing through the flange and the front plate part; screwing the head shell part and the front plate part through the hole by a second material containing the metal; and welding the first and the second materials.

Preferably, the fabrication method further comprises a step of: milling the front plate part and the second material containing the metal to form an even hitting surface of the front plate part after the welding.

Preferably, the head shell part provided is one of an iron club head, a wood club, and a putter head.

Preferably, the head shell part and the front plate part are made of materials containing different metals.

Preferably, the metal is titanium, and the head shell part is made of one of a steel material and a ferrous material.

Preferably, the trench and protrusion are prepared by a CNC method.

Preferably, the front plate part is cup-shaped.

As the melting element for securing the engaging of the protrusion and the trench contains the same metal as that of the front plate part, the composite club head obtained through the present invention becomes much integral, thus the sweet spot area is enlarged to an extent that equals to the front plate part, and the product reliability is increased and the fabrication cost is decreased. Meanwhile, as a trench and a protrusion provided on the main body part and the front plate part, the process is simplified and the time and costs are reduced. In addition, the simplified fabrication method of the present invention increases the fabrication efficiency and yield. As the front plate part is made of a lighter material in comparison with that of the main body part, center of gravity of the composite club head is able to be shift to the main body part, which increase the stability of the composite club head, and is more friendly for users.

### BRIEF DESCRIPTION OF THE DRAWINGS

The present invention can be more fully understood by reading the following detailed description of the preferred embodiments, with reference made to the accompanying drawings, wherein:

FIGS. 1 to 3 are schematic diagrams showing a fabrication method of a composite club head according to a first embodiment of the present invention; and

FIG. 4 is a schematic diagram showing a composite club head according to a second embodiment of the present invention;

FIGS. 5A and 5B are two partial cross-sectional views of composite golf club heads according to embodiments of the present invention.

FIGS. 6A and 6B are two partial cross-sectional views of composite golf club heads according to another embodiments of the present invention.

### DETAILED DESCRIPTION OF THE PREFERRED EMBODIMENTS

The following illustrative embodiments are provided to illustrate the disclosure of the present invention, these and other advantages and effects can be apparent to those skilled in the art after reading the disclosure of this specification. The present invention can also be performed or applied by other different embodiments. The details of the specification may be on the basis of different points and applications, and numerous modifications and variations can be made without departing from the spirit of the present invention.

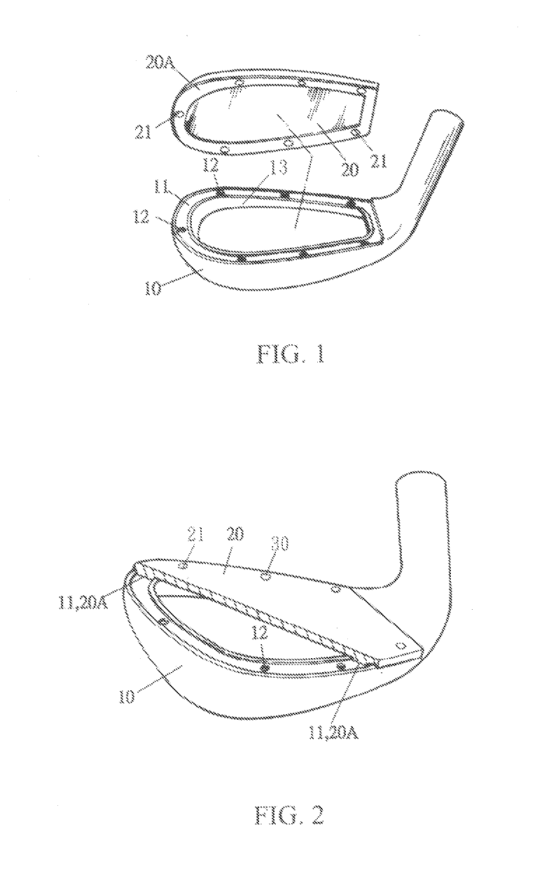

Please refer to FIGS. 1 and 2, which are schematic diagrams showing a fabrication method of a composite club head according to a first embodiment of the present invention. As shown in the diagrams, a main body part 10 of an iron club head is provided, wherein the main body part 10 is an open-front hollow main body part having a flange 13 around the open-front, and is milled by CNC method to have a trench 11 on the flange 13. A front plate part 20 made of a first titanium containing material and having a protrusion 20A is provided, wherein the protrusion 20A is prepared by milling on the periphery of the front plate part 20 by CNC method to allow the protrusion 20A of the front plate part 20 to be able to engage with the trench 11 of the main body part 10.

Then, engaging the front plate part 20 and the main body part 10 by engaging the trench 11 and the protrusion 20A as in FIG. 2. The front plate part 20 and the main body part 10 are drilled with through holes 21 and 12 simultaneous after the engaging of the trench 11 and the protrusion 20A, where the holes 21 are disposed on the protrusion 20A and are passing through the front plate part 20, and the through holes 12 are disposed on the trench 11 and passing through the flange 13. Alternatively, drilling of through holes 21 and 12 can be carried independently, where the through holes 21 are corresponding to the through holes 12.

After drilling, screwing the main body part 10 and the front plate part 20 through the holes 12 and 21 by a screw 30 made of a second titanium containing material. Then welding titanium-containing materials, i.e. the screw 30 and the front plate part 20.

Then, as shown in FIG. 3, the welded front plate part 20 and the screw 30 are milled from an even hitting surface 31 with strips 32 of the front plate part 20, thus the composite club head is formed.

Alternatively, the front plate 20 can be made of a maraging steel containing material and the accordingly screw 30 used is made of the same of different materials as long as it also contains maraging steel.

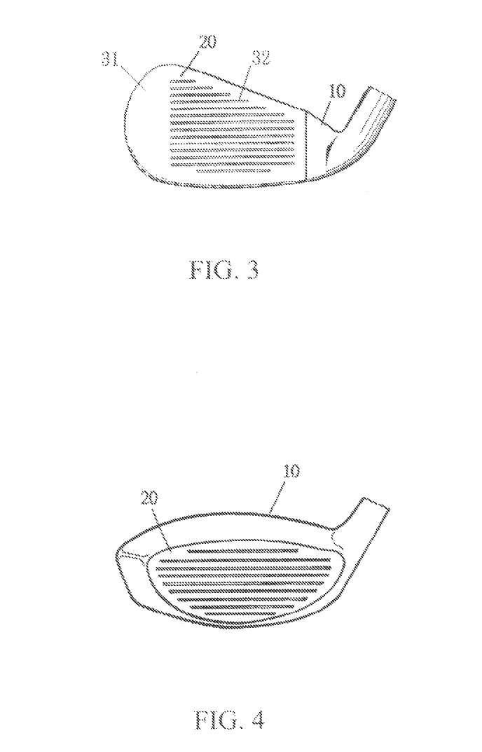

Please refer to FIG. 4, which is a schematic diagram showing a composite club head according to a second embodiment of the present invention. The main difference of the present embodiment from the first embodiment is that the main body part of the first embodiment is an iron club head and a main body part 20 of the present embodiment is a wood club head

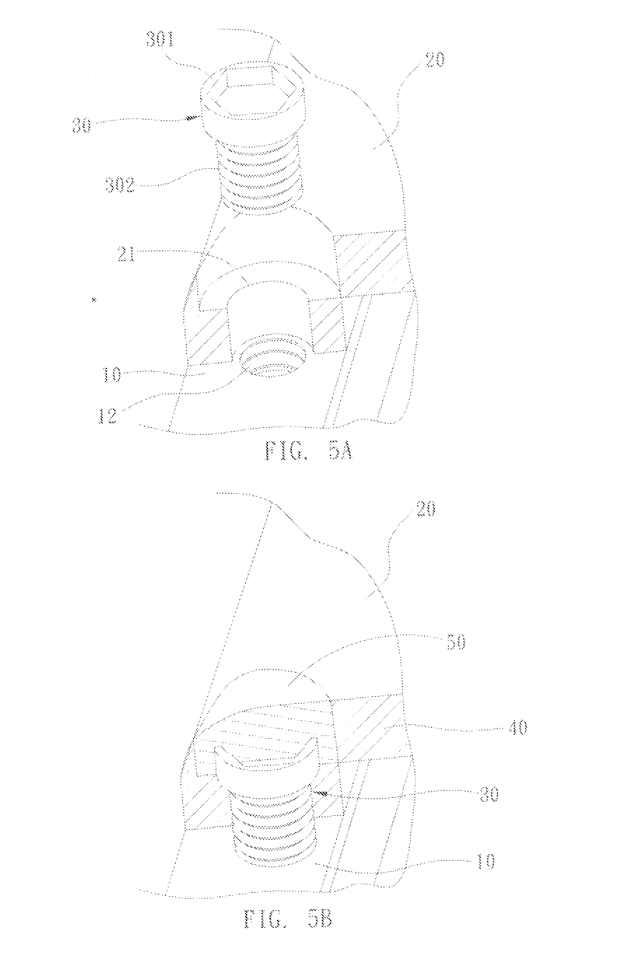

Please refer to FIG. 5A, which is a partial cross-sectional view of a composite golf club head according to an embodiment of the present invention. As shown in FIG. 5A, screw 30 has a head 301 and a body 302 with a thread engaging to the screw hole 12. The through hole 21 has a diameter (or a cross-sectional area) larger than that of the body 302 but smaller than that of the head 301. The through hole 21 has an inner wall free of threads. Therefore, when the screw 30 passes through the through hole 21 and secures itself in the screw hole 12, the head 301 facilitates a tight pressing of the front plate part 20 against the main body part 10. In this embodiment, the head 301 has a diameter of 5 mm; the body 302 has a diameter of 3.4 mm; and the through hole 21 has a diameter of 4 mm.

FIG. 5B shows another embodiment of the present invention. In the embodiment, a screw 30 has a length smaller than the overall length of a screw hole 12 and a through hole 21, such that the screw 30 secures itself in the screw hole 12 after passing through the through hole 21. Further, after a front plate part 20 is tightly pressed against the main body part 10, there is an accommodating space 40 still reserved in the through hole 21. Sequentially, an welding element 50, which is a material the same as that of the front plate part 20 and screw 30, is filled into the accommodating space 40, for subsequent working process such as welding, milling, and/or polishing so as to integrate the front plate part 20 and the filled welding element. As a result, the front plate part 20 and the main body part 10 are not only tightly secured together, but also result in the efficacy that the sweet spot area is intrinsically enlarged to the entire hitting surface.

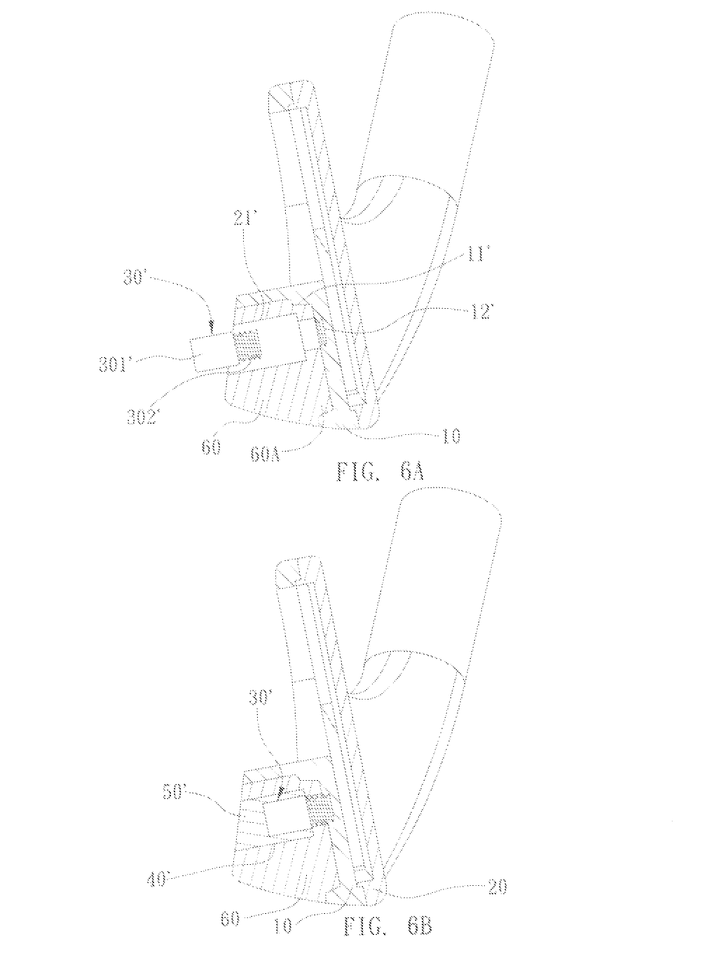

Please refer to FIGS. 6A and 6B, which illustrate a partial cross-sectional view of a composite golf club head according to an embodiment of the present invention. In the embodiment, the composite golf club head of the present invention further comprises a counterweight 60 which is made of a material containing a metal and has a protrusion 60A. The counterweight 60 is securely attached to the main body part 10. As shown in FIG. 6A, a through hole 21′ is disposed at the counterweight 60, and a trench 11′, which is corresponding to and for accommodating the counterweight 60, is disposed at the rear of the main body part 10. In addition, a screw hole 12′ is disposed at a position of the main body part 10 which corresponds to the through hole 21′. A screw 30′ has a head 301′ and a body 302′ with a thread engaging to the screw hole 12′. The through hole 21′ has a diameter (or a cross-sectional area) larger than that of the body 302′ but smaller than that of the head 301′. The through hole 21′ has an inner wall free of threads. Therefore, when the screw 30′ passes through the through hole 21′ and secures itself in the screw hole 12′, the head 301′ facilitates a tight pressing of the counterweight 60 against the main body part 10.

As shown in FIG. 6B, in the embodiment of the present invention a screw 30′ has a length smaller than the overall length of a screw hole 12′ and a through hole 21′, such that the screw 30′ secures itself in the screw hole 12′ after passing through the through hole 21′. Further, after a the counterweight 60 is tightly pressed against the main body part 10, there is an accommodating space 40′ reserved in the through hole 21′. Sequentially, an welding element 50′, which is a material same as that of the counterweight 60 and screw 30′, is filled into the accommodating space 40′, for subsequent working process such as welding, milling, and/or polishing so as to integrate the counterweight 60 and the filled welding element. As a result, the counterweight 60 and the main body part 10 are not only tightly secured together.

In various embodiments, the counterweight 60 may engages with the main body part 10 by virtue of a dove-tail groove or a right-angle or disc-shape oblique plane, and then the counterweight 60 can tightly secures itself to the main body part 10 through the screw 30′, the through hole 21′ and hole 12′.

What is claimed is:

1. A composite golf club head, comprising:
an open-front hollow main body part having a first trench disposed at a periphery of a front of the main body part and a first screw hole passing through the first trench;
a front plate part made of a material containing a metal and having a first protrusion disposed at a periphery of the front plate part and a first through hole disposed on the first protrusion and passing through the front plate part, wherein the front plate part is attached to the front of the main body part by an engaging of the protrusion and the first trench;
a first screw made of the same material as that of the front plate part and being for securing the engaging by passing through the first through holes, so as to be secured with the first screw hole and welded with the front plate part, and
a first welding element made of the same material as that of the front plate part and welded with the front plate part and the first screw after the first screw being secured with the first screw hole,
wherein the overall length of the first screw hole and the first through hole is longer than the length of the first screw, and a cross-sectional area of the first through hole is greater than the cross-sectional area of a body of the first screw but smaller than the cross-sectional area of a head of the first screw.

2. The golf club head of claim 1, wherein the front plate part is a cup-shaped plate.

3. The golf club head of claim 1, wherein the main body part is made of one of a steel material and a ferrous material.

4. The golf club head of claim 1, wherein the main body is one of an iron club head, a wood club, and a putter head.

5. The golf club head of claim 1, wherein the metal is one of titanium and a maraging steel.

6. The golf club head of claim 1, wherein the open-front hollow main body part has a second trench disposed at a rear of the main body part and a second screw hole passing through the second trench, the golf club head further comprising:
a counterweight made of a material containing a metal and having a second protrusion disposed at a periphery of the front plate part and a second through hole disposed on the second protrusion and passing through the front plate part, wherein the front plate part is attached to the front of the main body part by an engaging of the first protrusion and the first trench;
a second screw made of the same material as the of the counterweight and being for securing the engaging by passing through the second through hole, so as to be secured with the second screw hole and welded with the counterweight; and
a second welding element made of the same material as that of the counterweight and being for welding with the counterweight and the second screw after the second screw being secured with the second screw hole,
wherein the overall length of the second screw hole and the second through hole is longer than the length of the second screw, and a cross-sectional area of the second through hole is greater than the cross-sectional area of a body of the second screw but smaller than the cross-sectional area of a head of the second screw.

7. A fabrication method for a composite golf club head, comprising the steps of:
preparing a head shell part having an opened front, a flange around the opened front, and a trench on the flange, and a front plate part made of a first material containing a metal and having a protrusion;
connecting the head shell part with the front plate part by engaging the trench and the protrusion;
drilling a hole passing through the flange and the front plate part;
screwing the head shell part and the front plate part through the hole by a second material containing the metal; and
welding the first and the second materials.

8. The fabrication method claim 7, further comprising a step of:
milling the front plate part and the second material containing the metal to form an even hitting surface of the front plate part after the welding.

9. The fabrication method claim 7, wherein the head shell part provided is one of an iron club head, a wood club, and a putter head.

10. The fabrication method claim 7, wherein the head shell part and the front plate part are made of materials containing different metals.

11. The fabrication method claim 7, wherein the metal is titanium, and the head shell part is made of one of a steel material and a ferrous material.

12. The fabrication method claim 7, wherein the trench and protrusion are prepared by a CNC method.

13. The fabrication method claim 7, wherein the front plate part is cup-shaped.
